(19) United States
(12) Patent Application Publication
(10) Pub. No.: US 2020/0265200 A1
(43) Pub. Date: Aug. 20, 2020

(54) DEVICE FOR OPTIMIZING THE OPERATION OF SPORTING OR LEISURE FACILITIES

(71) Applicant: APS MANAGEMENT, ORLEANS (FR)

(72) Inventor: OLIVIER BEGUE, SAINT-PRYVÉ SAINT-MESMIN (FR)

(21) Appl. No.: 15/781,464

(22) PCT Filed: Dec. 3, 2015
(86) PCT No.: PCT/FR2015/053315

§ 371 Date: Jun. 4, 2018

(51) Int. Cl. G06K 7/10; G06F 16/25

(52) U.S. Cl. CPC G06K 7/10297; G06F 16/252

(57) ABSTRACT

A device for managing the occupancy of a sporting or leisure facility by users. Each badge includes a data memory specific to a user and a RFID type contact communicator. A database contains information specific to each user or player and a computer is connected to the database. A plurality of fixed terminals or stations are placed at different locations of the facility. Each fixed terminal or station includes an RFID device to scan and recognize the badges and a wireless communicator to wirelessly communicate with the database. Preferably, a radiofrequency transmitter/receiver operating at a frequency between 600 MHz and 1200 MHz, and particularly 868 MHz, provides communication between each terminal and the database.

### RELATED APPLICATIONS

This application is a § 371 application from PCT/FR2015/053315 filed Feb. 2, 2016, which is incorporated herein by reference in its entirety.

### FIELD OF THE INVENTION

This invention relates to a device for optimizing the operating of a leisure or sporting establishment such as a golf course, in order to communicate with the users/players.

### BACKGROUND OF THE INVENTION

The management of leisure establishments and/or venues that use a membership system makes it necessary to optimize the occupancy of the facilities of said establishment, and, in the example of a golf club, of the course itself and the other amenities (locker rooms, parking lots, practice booking, course booking, lessons etc.).

Such management is aimed at:
managing the load/occupancy of the facilities, such as a golf course, in real time, with the possibility to start using the course midway through it, for example, or managing the spaces available in the support amenities (parking lot, restaurant, toilet blocks etc.);
handling an additional load of users, such as guest players, who are not members.

A method and a device for golf learners are known through application WO 2008/078923, comprising stations placed at each starting point of the golf course and adapted firstly to communicate via an RFID system with the badges allocated to the players, and secondly to film the movements of the players in order to give them later on to the players.

This known device does not address the needs of managing the use of the golf course as mentioned above.

Thus, to date and to the best of the applicant's knowledge, there are no devices adapted to manage the occupancy of sporting or leisure facilities, particularly golf courses.

### OBJECT AND SUMMARY OF THE INVENTION

The invention remedies this situation and discloses a device for optimally managing the occupancy of a sporting or leisure facility such as a golf course by persons such as golf players, so as to reconcile the business requirements of the operator of said facility with the comfort and convenience of users/players.

To that end, according to the invention, the device intended for managing the occupancy of a sporting or leisure facility by users, of the type comprising:
a plurality of badges, each comprising firstly data memory means specific to a user and secondly RFID type contact communication means;
a database containing information specific to each user or player;
a computer connected to said database; and
a plurality of fixed terminals or stations placed at different locations of said facility, each comprising an RFID device for scanning and recognizing said badges and means for wireless communication with said database.

The invention is characterized in that the means for communication between each terminal and the database comprises a radiofrequency emitter/receiver.

That makes it possible to do away with the constraints or limits of other known wireless communication systems such as infrared, Wi-Fi or others.

Communication is carried out in narrowband frequency, and more particularly, the communication frequency ranges between 600 MHz and 1200 MHz, more precisely 868 MHz.

High frequency makes it possible to reduce the energy consumed and extend the battery life of the terminals. More particularly, the use of narrowband radiofrequency makes it easier to integrate the emitter in a small housing.

The range of the emitter/receiver of each terminal is thus long (10 km in obstacle-free terrain), allowing a high data download speed.

The selected frequency band is available without a license, and is thus free of charge.

The standby energy consumption is low and may be provided by photovoltaic cells with a lithium cell placed in the terminal.

Additionally, this makes it possible to activate the terminal only when a signal reaches it, by detecting the movement of a member's badge in the vicinity of the terminal, a capability made possible by means of a capacitive standby function that activates the RFID antenna of the independent interactive terminal.

Each badge is specific and personal to a member/user.

Said central computer makes it possible to keep the database of members and guests updated, particularly among other aspects as concerns the payment of their fees and their access permissions.

The terminals can continue to operate independently if the wireless transmission is lost.

To that end, the content of the database is transferred into the memory device of each terminal, allowing the terminals to take action or send a control signal to a device, such as for example a parking lot entrance barrier, without needing the central computer.

The device according to the invention further comprises one or more relay devices, called gateways, which are designed to exchange information and/or signals with said terminals via radiofrequency.

Each gateway comprises:
A gateway board 9 for communication with the database, more precisely including emitter/receiver equipment and an antenna operating in 868 megahertz narrowband, which is connected directly to the network of the central PC of the establishment or to one of the access nodes of the Ethernet network (wired or wireless) of the establishment;
a printed circuit board 4 comprising a radiofrequency emitter/receiver that operates in 868 MHz narrowband and comprises relay controls available for activating peripheral equipment such as a parking lot barrier, the ignition switch of a golf cart etc.;
a radio antenna 5 for communicating with the gateway, and
an induction type RFID antenna board 6 that supplies electricity to the badges and comprises an integrated transponder scanner to scan the members' badges, which makes it possible to program the customers' badges without needing an additional dedicated card reader.

868-megahertz narrowband allows the use of up to 200 terminals per emitting gateway.

Each terminal comprises:
a printed circuit board 4 comprising a radiofrequency emitter/receiver that operates in 868 MHz narrowband and comprises relays available for activating peripheral equipment such as a parking lot barrier, the ignition switch of a golf cart etc.
a radio antenna 5 for communicating with the gateway, and
an induction type RFID antenna board 6 that supplies electricity to the badges and comprises an integrated transponder scanner to scan the members' badges.

Advantageously, some of these terminals are each equipped with a relay board 7. Those same terminals can also be integrated into devices relating to the use or operating of the sporting or leisure facility such as:
A golf hand cart;
A parking lot barrier;
An electric cart; and
The door of a locker room.

These same terminals further comprise a display means 8.

Advantageously, said printed circuit boards of a given terminal are brought together in a slim-line housing, for example about 20 mm thick. The housing is protected from electromagnetic radiation (EMC).

Each badge is sealed and does not contain any cell or battery. They are activated by induction by an external source of electricity, which is activated when it is brought close to the transponder antenna of an interactive terminal.

The working of the device according to the invention is described below.

The independent or equipped interactive terminals communicate with the network gateway by means of an 868-megahertz narrowband radiofrequency link.

The terminals communicate with members' badges by means of a contactless RFID scanner activated by proximity detection.

In order to reduce the electricity consumed by the terminals, each of them has a capacitive standby function that activates the RFID antenna of the terminal only when a member's badge passes close to the terminal.

Members' badges can communicate directly with the network gateway when the badge passes before the gateway by means of an RFID reader dedicated to that gateway, which makes it possible to program the badges with no need for an additional card reader.

The working of the gateway or gateways 3 is as follows:
authorization request sent to the database via the network in read/write mode with local badge recognition; and
then exchange of data by radio with the independent interactive terminals.

The independent interactive terminal has the following functions:
alert and assistance function for isolated players (calling the cart etc.)
proximity badge scanning (on identified fixed point), for example at the entrance barrier of the parking lot;
access in mono-directional link:
   sending of an identifier from a member's badge using contactless technology (for example: parking lot access authorization request);
access in bi-directional link:
   offering the possibility to control peripheral devices (with dry relays from the housing), such as for example:
      controlling the opening of the parking lot barrier;
      ignition key (on-board housing) for using an electric cart;
      controlling the opening of a locker; and
      controlling the working of a golf ball dispenser (basket rental) for practice, or a tennis ball thrower etc.

If the central control PC experiences a power failure, the working is as follows:
the independent interactive terminals 2 retain the latest management status of the central database in a flash memory, which enables them to operate independently;
local transactions are stored and the transaction with the central PC is carried out by updating with the central PC when the radio link is restored; and
the signal is re-emitted automatically three times if there is any temporary conflict (e.g. hiding of antennas etc.).

If the radio link is lost (interference, stormy weather etc.), the radio link with the badges works as follows:
a “super badge” is used, which operates without authorization (master key function);
this “super badge” is obtained by giving “super badge” rights to an ordinary badge belonging to the manager or an authorized member of the staff; and
all the terminals are capable of detecting the super badge, but that master key function must not be hacked.

The “super badge” according to the invention remedies these drawbacks:
If the radio link between the gateway and the units is lost, super badges are used, which act as master keys and are provided to the manager of the golf course and authorized staff members; and
In order to protect those super-badges, a super-user code is generated by an encoded recognition mechanism common to all terminals, which allows them to recognize whether the super-user card presented has the required rights.

If the radiofrequency link between the gateway 3 and the interactive terminals 1 or 2 is lost, super badges are used, which act as master keys and are to be used by the manager, the users and possibly authorized members.

This presents the following benefits:
an ordinary member badge can at any time become a super-user badge without any distinctive sign;
There is no risk that following loss or a theft, an ordinary badge could become a special super-user badge; and
The super-user badge can be deactivated at any time.

Furthermore, a super-user recognition code common to all terminals 1 or 2 is generated by an algorithm contained in the printed circuit board specific to each interactive terminal, which makes it possible to recognize whether the member's badge has the required rights.

The algorithm produces a unique random code that allows the terminal to generate an original code that is renewed every time;

The benefits of this design are as follows:
An ordinary member badge can at any time become a super-user badge without any visible distinctive outer sign;
There is no risk relating to the theft of a special super-user badge, because:
   the super-user badge will be inactive in the absence of the access key;
   the super-user badge can be deactivated at any time remotely; and
This protection remains active when the radiofrequency link between the gateway 3 and the interactive terminals 1 or 2 is not operating.

### BRIEF DESCRIPTION OF THE DRAWINGS

One exemplary embodiment of the invention is shown in the attached drawings wherein:

FIG. 1 is an overview of the device according to the invention;

FIG. 2 is a perspective view of a badge;

FIG. 3 represents the housing of a terminal equipped with a display;

FIG. 4 is a perspective exploded view of a housing showing the different boards; and

FIG. 5 represents the housing of a terminal equipped with a display on its front.

### DETAILED DESCRIPTION OF THE EMBODIMENTS

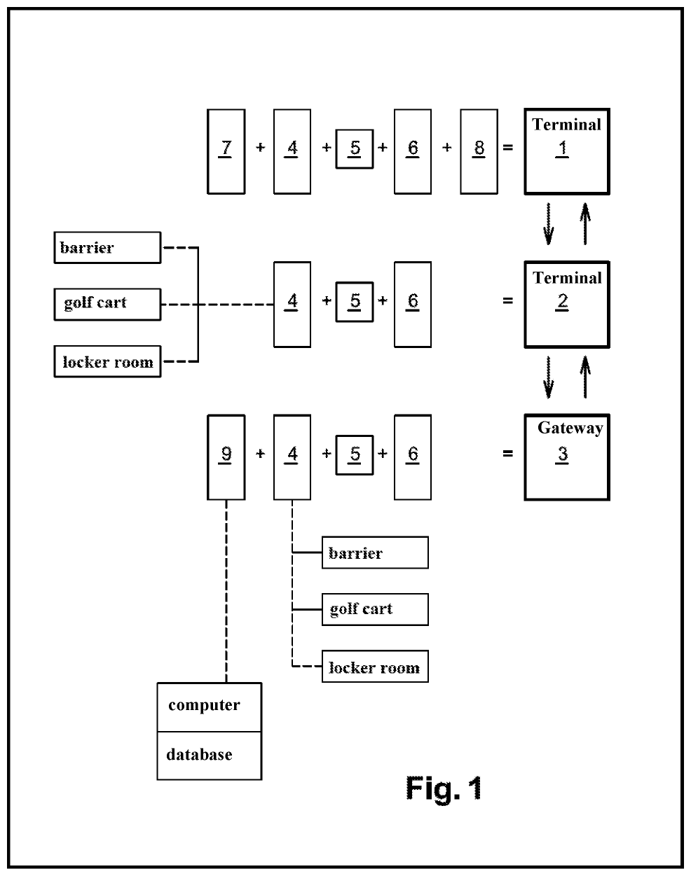

By reference to FIG. 1, the synoptic diagram of the non-wired links between the different parts that make up the system according to the invention is described below:
block 1 represents the content of an equipped interactive terminal 1, in which are grouped the printed circuit boards 7, 4, 5, 6, and the display 8; the relay board 7 comprises dry relays available for activating peripheral equipment such as a parking lot barrier or the ignition switch of a golf cart and its supply means via the network;
block 2 represents the content of an independent interactive terminal 2 containing the three printed circuit boards 4, 5, 6 below:
   a radio board 4, relay control, control indicated by a LED indicator and RFID radiofrequency scanner,
   a radio antenna 5,
   an RFID antenna board 6;
block 3 represents the content of a network gateway 3, in which are grouped the printed circuit boards 4, 5, 6, the radio board 9 acting as the gateway with the database contained in the central PC of the operator (not shown).

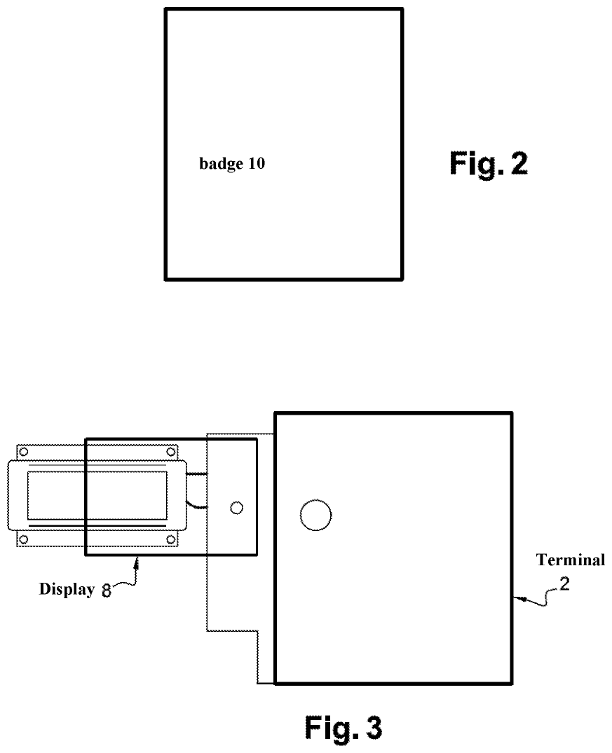

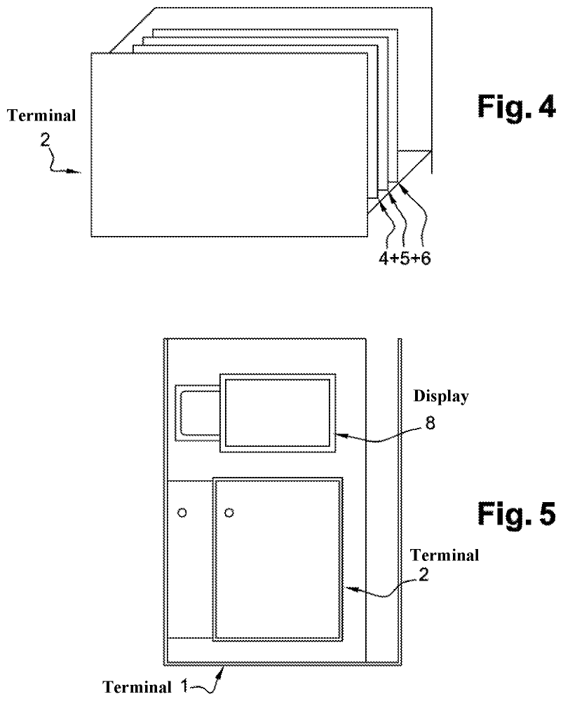

Note that the members' badges are schematically shown in FIG. 2, but the central operating PC is not shown, which is connected to an access node to a computer network and communicates with the network gateway 3.

The field of application of the invention includes the management of leisure clubs such as:
racing clubs
hunting grounds
sports clubs (archery range, shooting range etc.)
tennis clubs
hotels and leisure facilities.

A system for managing golf courses made up of five elements:
a plurality of independent interactive terminals 2 containing the three printed circuit boards below:
   radio board 4 containing a relay control indicated by an LED indicator and an RFID radiofrequency scanner,
   a radio antenna 5, and
   an RFID antenna board 6;
a plurality of equipped interactive terminals 1 additionally containing, in addition to the three printed circuit boards contained in the independent interactive terminal 2:
   a display 8, and
   a relay board 7 available for activating peripheral devices, such as a parking lot barrier, the ignition switch of a golf cart and its supply means via the network,
a plurality of members' badges 10;
at least one network gateway 3; and
wherein the last is connected to a CENTRAL CONTROL PC or an access node to a network of computers.

These elements are characterized by their modes of communicating with each other in order to continuously ensure transmission in established mode and their working in fault-tolerant mode by using the following measures:
the equipped or independent interactive terminals communicate with the network gateway by means of an 868-megahertz narrowband radiofrequency link, and operate independently using remote storage of the members' database if the radiofrequency link with the central control computer is lost and send back to the CENTRAL CONTROL COMPUTER the data stored during the period of interruption after the radiofrequency link is restored.
the equipped or independent interactive terminals communicate with the members' badges by means of a contactless RFID scanner, and
   are activated only by capacitive detection when members' badges pass in the vicinity, and
   go into standby mode regarding communication with the gateway away from that presence, which reduces their electricity consumption;
members' badges 10 communicate with the network gateway 3 by means of an RFID reader dedicated to that gateway, which makes it possible to program the badges 10 with no need for an additional card reader, and operate independently without any electricity supply source, thanks to an internal antenna that is coupled with induction loops contained in the equipped or independent interactive terminals and the network gateway 3.

A system for managing golf courses according to the claimed invention, characterized in that if the radiofrequency link between the network gateway 3 and the equipped or independent interactive terminals is lost, the manager of the golf course, the users and possibly authorized members use super-user badges that act as master keys and give access to all the services of the golf course.

A system for managing golf courses that uses super-user badges 10 according to claimed invention, characterized in that the creation mode of a super-user badge uses a recognition code common to all the equipped or independent interactive terminals, which recognition code is generated by an algorithm contained in the printed circuit board specific to each interactive terminal, which makes it possible to recognize if the member's badge has the required rights.

The formula of the algorithm produces a unique random cipher that allows the terminal to generate an original code that is renewed every time; and therefore:
An ordinary member badge 10 can at any time become a super-user badge 10 without any visible distinctive outer sign;
There is no risk of a theft of a special master key badge, because:
   the super-user badge 10 is inactive in the absence of the access key;
   the super-user badge 10 can be deactivated at any time remotely; and
      such protection remains active when the radiofrequency link between the network gateway 3 and the equipped or independent interactive terminals is not operating.

A system for managing golf courses according to the claimed invention, characterized by the low electricity consumption of the equipped or independent interactive terminals, achieved by means of a capacitive standby function that activates the RFID antenna of the terminal only when a member's badge 10 passes close to it following deliberate action by the holder.

A system for managing golf courses according to the claimed invention, characterized in that the outer design of the housing containing the printed circuit boards contained in the equipped or independent interactive terminals must be as flat as possible in order to reduce the distance between the badge and the induction loop contained in that housing and the housing is protected by metal shielding from electromagnetic radiation (EMC).

A system for managing golf courses according to claimed invention, characterized in that the electricity supply to the housing containing the printed circuit boards contained in the independent interactive terminal is provided by:
a lithium cell, or
photovoltaic cells and a battery.

A system for managing golf courses according to the claimed invention, characterized in that the sealed member's badge does not contain a cell or any other source of electricity; it is powered by an electric induction antenna that is activated automatically when it is brought close to the induction loop contained in each independent interactive terminal, and is thus not subject to wear.

1-10. (canceled)

11. A device to manage an occupancy of a sporting or leisure facility by users or players, comprising:
a plurality of badges, each badge comprising a data memory specific to a user and a RFID type contact communicator;
a database containing information specific to each user or player;
a computer connected to said database;
a plurality of fixed terminals or stations placed at different locations of said sporting or leisure facility, each terminal or station comprising: an RFID reader configured to scan and recognize said plurality of badges; and a wireless communicator configured to wirelessly communicate with said database; and
wherein the wireless communicator of each terminal or station comprises a radiofrequency transmitter/receiver.

12. The device according to claim 11, wherein the radiofrequency transmitter/receiver is configured to communicate in a narrowband frequency.

13. The device according to claim 12, wherein the radiofrequency transmitter/receiver is configured to operate at a frequency range between 600 MHz and 1200 MHz.

14. The device according to claim 13, wherein the radiofrequency transmitter/receiver is configured to operate at a frequency of 868 MHz.

15. The device according to claim 11, wherein each terminal comprises a memory to store content of the database; and wherein said each terminal is configured to operate independently in response a loss of wireless transmission between the said each terminal and the database.

16. The device according to claim 11, further comprising one or more gateways, each gateway is configured to exchange at least one of information and signals with said plurality of terminals via a radiofrequency.

17. The device according to claim 16, wherein each gateway comprises:
a gateway board to communicate with the database, the gateway board comprising a transmitter/receiver and an antenna operating at 868 MHz narrowband frequency, which is connected directly to a network of a central computer of the sporting or leisure facility or to one of access nodes of a wired or wireless Ethernet network the sporting or leisure facility;
a printed circuit board comprising a radiofrequency transmitter/receiver operating at the 868 MHz narrowband frequency and relay controls configured to activate a peripheral equipment;
a radio antenna to communicate with said plurality of terminals; and
an induction type RFID antenna board configured to supply electricity to said plurality of badges and comprising an integrated transponder scanner to scan said plurality of badges, thereby enabling a programming of said plurality of badges without requiring an additional dedicated card reader.

18. The device according to claim 17, wherein the peripheral equipment is a parking lot barrier or an ignition switch of a golf cart.

19. The device according to claim 11, wherein said each terminal comprises:
a printed circuit board comprising a radiofrequency transmitter/receiver operating at 868 MHz narrowband frequency and relays configured to active a peripheral equipment;
a radio antenna to communicate with said plurality of gateways; and
an induction type RFID antenna board configured to supply electricity to said plurality of badges and comprising an integrated transponder scanner to scan said plurality of badges.

20. The device according to claim 19, wherein the peripheral equipment is a parking lot barrier or an ignition switch of a golf cart.

21. The device according to claim 11, wherein each of a subset of the terminals is equipped with a relay board, and the subset of the terminals are integrable into an equipment of the sporting or leisure facility.

22. The device according to claim 21, wherein the equipment of the sporting or leisure facility is a golf hand cart, a parking lot barrier, an electric cart, or a door of a locker room.

23. The device according to claim 21, wherein said each of the subset of the terminals further comprises a display.

24. The device according to claim 19, wherein said each terminal further comprises a housing to house the printed circuit board and the induction type RFID antenna board.

25. The device according to claim 24, wherein a thickness of the housing is 20 mm.

26. The device according to claim 24, wherein the housing is an electromagnetic radiation (EMC) protected housing.

27. The device according to claim 11, wherein said each badge is sealed and does not contain any cell or battery.
